(19) United States
(12) Patent Application Publication
(10) Pub. No.: US 2012/0259715 A1
(43) Pub. Date: Oct. 11, 2012

(54) INFORMATION GATHERING AND DECODING USING NEAR FIELD WIRELESS COMMUNICATION

(75) Inventors: Jeffrey T. Robson, Eugene, OR (US); Harold C. Clifford, Greenback, TN (US); Mildred A. Clifford, Greenback, TN (US)

(73) Assignee: DATALOGIC ADC, INC., Eugene, OR (US)

(21) Appl. No.: 13/364,969

(22) Filed: Feb. 2, 2012

Related U.S. Application Data
(60) Provisional application No. 61/438,886, filed on Feb. 2, 2011.

(51) Int. Cl. G06Q 20/20; H04B 5/00

(52) U.S. Cl. 705/16

(57) ABSTRACT

An information gathering apparatus, such as a point-of-sale (POS) system may include a wireless data capture device capable of obtaining customer information from a wireless-enabled customer device. Data obtained by the wireless data capture device may be converted into a format that is compatible with a corresponding POS computer system. The wirelessly obtained data may be transmitted to the POS system along with data gathered using conventional data capture devices, such as optical readers, bar code scanners, radio frequency identifier (RFID) readers, and the like.

### CROSS-REFERENCE TO RELATED APPLICATIONS

This application claims priority to U.S. Provisional Patent Application No. 61/438,886 filed on Feb. 2, 2011, and entitled “Information Gathering and Decoding Using Near Field Wireless Communication,” which is hereby incorporated by reference in its entirety.

### BACKGROUND

The field of the present disclosure relates to information gathering and decoding methods and apparatuses configured to obtain customer information and, in particular, to obtain customer information wirelessly for use in a point-of-sale (“POS”) system.

Typically, “check out” operations in retail POS systems involve an operator using a data capture device to gather information regarding a customer transaction. A POS system may include a data capture device attached to a POS terminal, which may be used to acquire information pertaining to the customer's items. The data capture device may comprise a fixed or handheld data reader such as an optical reader that may scan barcode information on the customer items and provide the barcode information to the POS.

The POS transaction may further include the customer tendering information to the POS operator. The information may include, but is not limited to: qualification information (e.g., age verification), store membership or loyalty information, coupons, payment information, and so on. Gathering this information from the customer may be a time-intensive process in which the customer physically tenders items (cards, printed media, and so on) from which the information is obtained. For example, tendering coupons may require the customer presenting physical coupons to the POS operator and scanning the individual coupons using a data capture device (e.g., barcode scanner).

The present inventors have recognized a need for an information gathering and decoding method and apparatus that is capable of acquiring customer information more efficiently without requiring significant modifications to the retailer's POS system. POS systems are typically implemented in complex computing environments that include large databases, multiple data capture and/or communication devices, and the like. Changes to the software and/or hardware of the POS system can introduce bugs, memory leaks, or other errors, resulting in downtime and lost revenue for the retailer. Accordingly, although existing mechanisms for acquiring customer information have many drawbacks, retailers may be hesitant to make significant modifications to their POS systems to address these issues.

### SUMMARY

The present inventors have recognized the potential to address many of the issues of existing POS systems by employing wireless communication mechanisms for gathering and/or decoding customer information. In some embodiments, an information gathering apparatus gathers information pertaining to a customer transaction using a first data capture device. A wireless data capture device is used to obtain customer information from a wireless-enabled customer device. The customer information is converted into a format that is compatible with the POS system, and the customer information is provided to the POS system.

In some embodiments, information pertaining to a customer transaction is gathered by a remote information gathering apparatus. The remote information gathering apparatus stores the information on a wireless-enabled storage device and/or a wireless-enabled customer device. Another information gathering apparatus obtains the stored information, and uses the stored information to complete the customer transaction. The remote information gathering apparatus may be a mobile apparatus for use in a queue busing scheme. Alternatively, the remote information gathering apparatus may be fixed. The remote information gathering apparatus may store the information pertaining to the customer transaction on a backend controller (or other storage service), and may store a link or reference to the information on the wireless-enabled storage device and/or the wireless-enabled customer device. Another information gathering apparatus may access the information using the link or reference.

Additional aspects and advantages will be apparent from the following detailed description of preferred embodiments, which proceeds with reference to the accompanying drawings.

### BRIEF DESCRIPTION OF THE DRAWINGS

Non-limiting and non-exhaustive embodiments of the disclosure are described, including various embodiments of the disclosure with reference to the figures, in which:

FIG. 1 is a schematic diagram of one embodiment of an information gathering apparatus;

FIG. 2A is a schematic diagram of one embodiment of a mobile information gathering apparatus;

FIG. 2B depicts one embodiment of a system for queue busting;

FIG. 3A is a schematic diagram of one embodiment of a fixed information gathering apparatus and a mobile information gathering apparatus for use in a queue-busting scheme;

FIG. 3B is a schematic diagram of one embodiment of a fixed information gathering apparatus and a remote information gathering apparatus to gather information pertaining to a transaction;

FIG. 4 is a flow chart of one embodiment of a method for gathering information pertaining to a customer transaction;

FIG. 5 is a flow chart of another embodiment of a method for gathering information pertaining to a customer transaction;

FIG. 6 is a flow chart of one embodiment of a method for queue busting using a mobile information gathering apparatus; and

FIG. 7 is a flow chart of another embodiment of a method for gathering information pertaining to a customer transaction.

### DETAILED DESCRIPTION

In the following description, numerous specific details are provided for a thorough understanding of the various embodiments disclosed herein. However, those skilled in the art will recognize that the systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

Preferred embodiments will now be described with reference to the drawings. While several preferred embodiments are described with reference to a fixed information gathering apparatus and a mobile information gathering apparatus, the principles described herein are viable in other applications and/or configurations. For example, the data capture devices referenced in various embodiments may be of the fixed or portable type; a fixed information gathering apparatus may include a fixed data reader such as an in-counter or on-counter barcode scanner and/or a portable data reader such as a handheld barcode scanner or portable data terminal. The same or similar data capture devices may be used in conjunction with a mobile information gathering apparatus. The described embodiments, as well as other embodiments, have numerous applications wherein a plurality of information gathering apparatuses are employed and embodiments may be scaled and adapted to many applications.

The present inventors have recognized advantages for an information gathering and decoding method and apparatus that is capable of acquiring customer information more efficiently without making significant modifications to the retailer's POS system, and that customer information may be obtained using a wireless data capture device coupled to an information gathering apparatus, such as a fixed or portable data reader, such as a barcode scanner. Gathering customer information wirelessly obviates the need to perform time-consuming manual operations.

An information gathering apparatus as disclosed herein may be configured to convert information obtained wirelessly into a format that is compatible with the POS system (a “POS format”), such that the wireless data capture device may be integrated without significant modifications to the POS system. As used herein, a POS format refers to any data format that is compatible with a POS system. Accordingly, a “POS format” refers to a data format that can be received and/or processed by a POS system. In some cases, a POS format refers to a one-dimensional, stacked, or two-dimensional barcode format, which may include, but is not limited to: Interleaved 2 of 5, Code 39, Code 93, Code 128, Codabar, EAN 8, EAN 13, UPC-A, UPC-E, PDF417, GS1 Databar, Datamatrix, Maxicode, or the like.

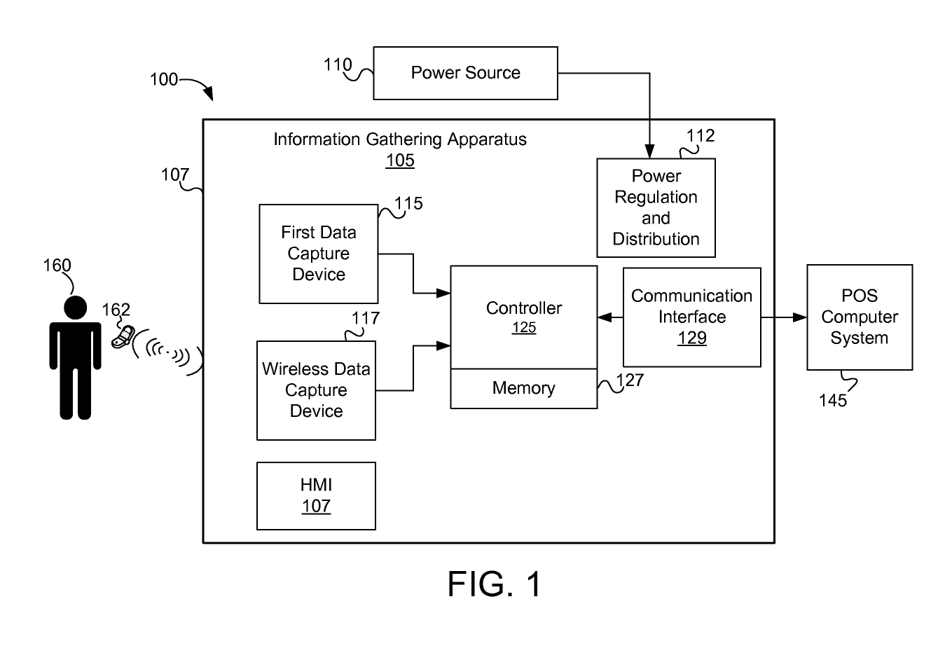

Referring now to the drawings, FIG. 1 is a schematic diagram 100 of one embodiment of an information gathering apparatus 105. The information gathering apparatus 105 is powered by a power source 110, such as an alternating-current source (e.g., wall outlet) connected to a power grid, a battery, or other source. The power source 110 may be external or internal to the housing 107 of the information gathering apparatus 105. The power source 110 powers a power regulation and distribution system 112, which distributes power to various components and/or devices of the apparatus 105. Although a power connection is only illustrated from the power source 110 to the power regulation and distribution module 112, suitable connections to other components 107, 115, 117, 129, 125, 127, and 129 may also exist, but are omitted from FIG. 1 to avoid obscuring other aspects of the information gathering apparatus 105.

The apparatus 105 comprises a first data capture device 115 and a wireless data capture device 117. The first data capture device 115 may comprise one or more optical code readers that utilize optical means (e.g., laser, imager, or the like) to obtain data from printed media, such as a printed barcode. Accordingly, the first data capture device 115 may comprise a flying spot laser barcode scanner, imaging reader, image recognition device, image processing system (Optical Character Recognition (OCR) system), or the like. Alternatively, or in addition, the first data capture device 115 may include a radio frequency identification (RFID) reader, a magnetic stripe reader, or any other suitable device for capturing information pertaining to a customer transaction. The first data capture device 115 (as well as the wireless data capture device 117, discussed below) may be configured to obtain data using various different techniques in various different manners. Accordingly, references to scanning, reading, and/or gathering information should be understood to include any data acquisition techniques and/or mechanisms known in the art.

The first data capture device 115 is configured to gather data pertaining to items in a POS transaction. As described above, the first data capture device 115 may obtain data from printed media barcodes, RFID tags, or from other media.

The data capture device 115 is operatively connected to a controller 125. The controller 125 may comprise a processor, such as a general-purpose processor (e.g., central processing unit (CPU), or the like), a special purpose processor, a Field-Programmable Gate Array (FPGA), or the like. The controller 125 comprises and/or is communicatively coupled to memory storage 127, which may be incorporated as part of the controller 125 or provided as a separate component. The memory 127 may be implemented using any suitable data storage mechanism, including, but not limited to: random access memory (RAM), such as DRAM, or the like, non-volatile, solid-state storage, such as Flash memory, hard disk storage, optical storage media, or the like. In some embodiments, the memory 127 may comprise a non-transitory storage medium, having stored thereon machine-readable and/or executable instructions configured to cause the information gathering apparatus 105 to perform various methods for gathering and/or decoding customer information.

The controller 125 is operatively connected to a POS computer system 145. The controller 125 communicates with the POS computer system 145 to provide the POS computer system 145 with information obtained by the first data capture device 115 and/or the wireless data capture device 117. The information may be provided in a suitable format that is compatible with the POS computer system 145. The controller 125 may be further configured to communicate information that is stored in the memory 127, communicate diagnostic information, status information, and so on. The controller 125 may communicate with the POS computer system 145 using one or more communication protocols. The controller 125 and computer system 145 may communicate over a hard-wired connection, a wireless network, or any other suitable communication medium. In some embodiments, the controller 125 may communicate with the POS computer system 145 via a communication interface 129, which may be adapted for communication with the POS computer system 145 according to a particular communication medium and/or protocol.

The information gathering apparatus 105 includes a wireless data capture device 117. In some embodiments, the wireless data capture device 117 is a Near Field Communication (NFC) device, having a limited communication range. The limited communication range of the NFC device 117 may be desirable to limit communication to the customer 160 who is currently engaged in the POS transaction and/or to prevent unauthorized or unwanted data capture. In alternative embodiments, the wireless data capture device 117 may comprise a BLUETOOTH® compatible device (BLUETOOTH is a registered trademark of BLUETOOTH SIG, Inc.), a low-power BLUETOOTH® device, a device capable of implementing one or more of the IEEE 802.11 standards, or the like.

The wireless data capture device 117 may be configured to wirelessly obtain information pertaining to a POS transaction from a wireless-enabled customer device 162. The information may include, but is not limited to: customer loyalty information (e.g., loyalty card, customer identifier, etc.), membership information (e.g., membership card, member identifier, etc.), coupons, payment information (e.g., credit card, debit card, food stamp card, etc.), and so on. The customer information may be obtained from various different wireless-enabled customer devices 162, which may include, but are not limited to: wireless-enabled storage devices or cards; communication devices, such as cellular phones, smart phones, or the like; personal digital assistants (PDAs); personal media players, such as an iPod Touch® player (iPod Touch is a registered trademark of Apple, Corp.), a Zune® player (Zune is a registered trademark of Microsoft, Corp.), computing devices (e.g., laptop computer, notebook computer, tablet computer, etc.), or any other suitable device.

As discussed above, the communication range of the wireless data capture device 117 may be limited for security reasons and/or due to the nature of the communication standards and/or protocols implemented thereby (e.g., to prevent eavesdropping, interference, cross talk, etc.). For example, the communication range of the NFC wireless data capture device 117 may be limited to approximately four (4) inches. The communication range of other types of wireless data capture devices 117 (e.g., low-power BLUETOOTH®) may be similarly limited. During a POS transaction, the customer 160 may be prompted to tender information using the wireless data capture device 117. The prompt may be offered by an operator of the information gathering apparatus 105, by signage, a display and/or other human-machine-interface (HMI) components 107 of the apparatus 105. The prompt may instruct the customer 160 to place or position a wireless-enabled customer device 162 into the communication range of the wireless data capture device 117.

In some embodiments, the wireless data capture device 117 is configured to automatically obtain customer information when a wireless-enabled customer device 162 is placed into its communication range. Alternatively, or in addition, the wireless data capture device 117 may require action and/or approval on the part of the customer 160 (or operator of the apparatus 105) before wirelessly capturing customer information. As mentioned above, the action may be the customer 160 moving the wireless-enabled device 162 into communication range of the wireless data capture device 117. Other actions may include, but are not limited to: responding to a prompt from the operator; responding to a prompt displayed on the HMI 107 of the apparatus 105; responding to a prompt displayed on the wireless-enabled customer device 162; or the like.

The operation of the wireless data capture device 117 may be managed by the controller 125 (and/or by a separate, independent controller, not shown). Data captured by the wireless data capture device 117 may include any type of customer information. The data may be formatted and/or encoded in various ways. The format of the data obtained using the wireless data capture device 117 may be incompatible with the POS computer system 145. Accordingly, the data obtained by the wireless data capture device 117 may be converted into a format that is compatible with the POS computer system 145. The conversion may comprise converting the obtained data from its original format and/or encoding into a POS format, such as a barcode format or the like. The converting may allow the POS computer system 145 to receive and/or process the information obtained by the wireless data capture device 117 without substantial modifications to the POS computer system 145.

One advantage of processing data from two (or more) different data capture devices (e.g., devices 115 and 117) and providing the information to the POS computer system 145 in a consistent format (as if the data originated from a single information gathering apparatus) is that there is no need to modify the POS computer system 145 to support the alternative data capture mechanisms (e.g., NFC wireless data capture methods). For example, the POS computer system 145 may use and/or access information obtained using an NFC device 117 in the same way the POS computer system 145 uses and/or accesses POS formatted data obtained by the first data capture device 115. Thus, gathering information from the customer 160 is made more efficient without significant modifications to the POS computer system 145.

As illustrated in FIG. 1, the wireless data capture device 117 may be positioned within the housing 107 of the information gathering apparatus 105. The wireless data capture device 117 may be positioned such that, during a POS transaction, the customer 160 is in proximity to the wireless data capture device 117. The wireless data capture device 117 may be prominently displayed to the customer 160 such that the customer 160 is alerted to the option of wirelessly tendering certain transaction-related information. As described above, in some embodiments, the communication range of the wireless data capture device 117 may be limited (e.g., four inches). Accordingly, gathering data from the device 162 may require the customer 160 to position the wireless-enabled customer device 162 within a communication range of the wireless data capture device 117 (e.g., within four inches of the wireless data capture device 117). When the wireless-enabled customer device 162 is in communication range, the wireless data capture device 117 may automatically obtain transaction-related customer data therefrom.

As discussed above, in some embodiments, data capture using the wireless data capture device 117 may be predicated on customer approval (in addition to the customer positioning the wireless-enabled customer device 162 into the communication range of the wireless data capture device 117). The information gathering apparatus 105 may provide various different customer approval mechanisms, which may include, but are not limited to: the operator of the apparatus 105 prompting the customer 160 for approval; a display (or other HMI components 107 of the apparatus 105) prompting the customer 160 for approval; causing the wireless-enabled customer device 162 to prompt the customer 160 for approval; accessing pre-stored customer-specific approval preferences (maintained by the POS computer system 145); or the like.

In some embodiments, customer approval is requested before accessing certain types of customer information from the wireless-enabled customer device 162. For instance, customer approval may be sought before accessing information that is considered to be private or sensitive, such as customer identifying information (e.g., name, address, etc.), birth date (for purchase qualification, discussed below), payment information (e.g., checking account number, credit card, Electronic Benefit Transfer (EBT) card, etc.), and the like. Other information that is not considered to be private and/or sensitive, such as coupons, customer loyalty information, and the like, may be accessed automatically and/or based on the initial customer acceptance described above.

When the wireless data capture device 117 gathers information from the wireless-enabled customer device 162, the information may be converted into a POS format that is compatible with the POS computer system 145 (e.g., barcode format). Converting the data may comprise reformatting the data, re-encoding the data, or the like. The conversion may comprise accessing formatting rules to map data obtained using the wireless data capture device 117 into the POS format (e.g., convert the customer information into discrete barcodes). The converted data may be provided to the POS computer system 145 along with data obtained by the first data capture device 115. The POS computer system 145 may use the information obtained by both devices 115 and 117 to complete the POS transaction with the customer 160.

In some embodiments, the wireless data capture device 117 may be capable of “pushing” information onto a wireless-enabled customer device 162. Accordingly, the wireless data capture device 117 may be capable of both receiving and transmitting information. Alternatively, the information gathering apparatus 105 may include a separate dedicated wireless transmitter (not shown). Information that may be pushed to the wireless-enabled customer device 162 may include, but is not limited to: promotional materials (e.g., information regarding upcoming sales, promotions, or the like); customer loyalty rewards information (e.g., current rewards point balance); an electronic receipt; warranty information, rebate redemption information, store account information (e.g., the current balance on a customer credit account); coupons; or the like.

In one example, the wireless data capture device 117 is used to transmit a coupon to the wireless-enabled customer device 162; the coupon may be stored on the wireless-enabled customer device 162 and made available for redemption during a subsequent POS transaction. Pushing information onto the customer device 162 may require the customer 160 to take an action and/or indicate approval for the transfer, as described above (e.g., require the customer 160 to move the wireless-enabled customer device 162 into communication range of the wireless data capture device 117, respond to a prompt, or the like). The approval for receiving pushed information may be in addition to the customer approval (if any) for accessing customer information from the wireless-enabled customer device 162.

As described above, in some embodiments, a POS system may comprise multiple data capture apparatuses. For example, a POS system may include a fixed information gathering apparatus (located at a POS terminal or checkout station) and a mobile data gathering apparatus. The two information apparatuses may be used simultaneously, in tandem, in a queue-busting scheme. The fixed information gathering apparatus is used to perform POS transactions for customers at the head of the queue, while the mobile information gathering apparatus is used to, inter alia, begin gathering information for customers further down the queue (“pre-checkout” processing). Apparatus, systems, and methods for gathering and decoding information using multiple data capture devices are described in U.S. Published Patent Application No. 2010/0257063, entitled “Information Gathering and Decoding Apparatus and Method of Use,” filed on Jun. 19, 2009, which is hereby incorporated by reference in its entirety.

The information gathering apparatus 105 (and/or the wireless data capture device 117) may be adapted for use in a queue-busting scheme. For example, customer information captured by a mobile data gathering apparatus in a pre-checkout process may be stored on a wireless-enabled storage device (e.g., wireless-enabled card, fob, token, or the like). The wireless-enabled storage device may include data pertaining to the customer's purchases (e.g., a list of products in the customer's basket), along with other customer information, such as loyalty card information, qualification information (e.g., age verification), payment information, and the like. The customer may present the wireless-enabled storage device at a POS terminal (e.g., checkout station), which may read the information pertaining to the transaction from the card (using a wireless-enabled device, such as the wireless data capture device 117) and quickly complete the POS transaction.

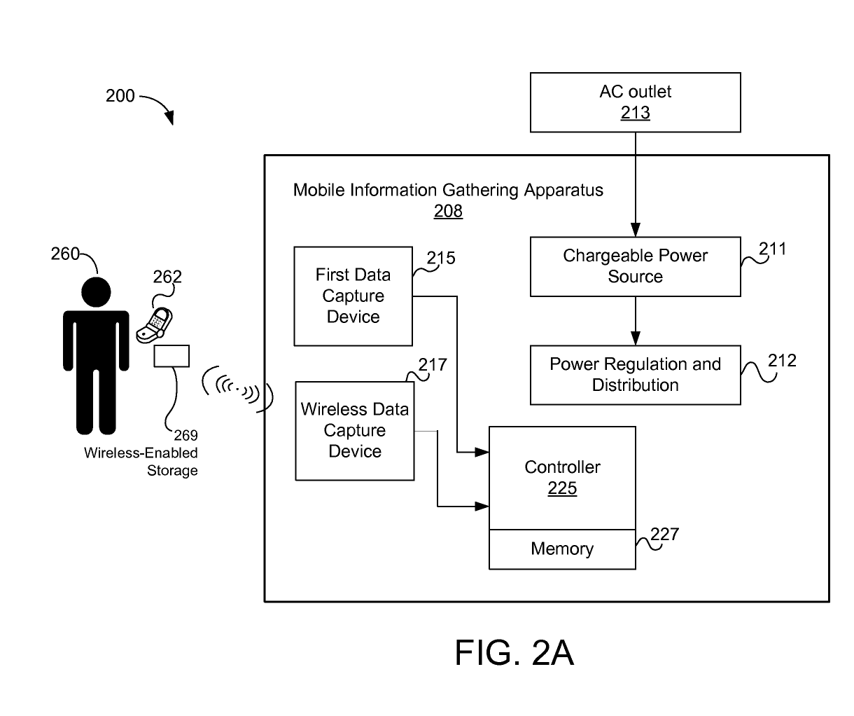

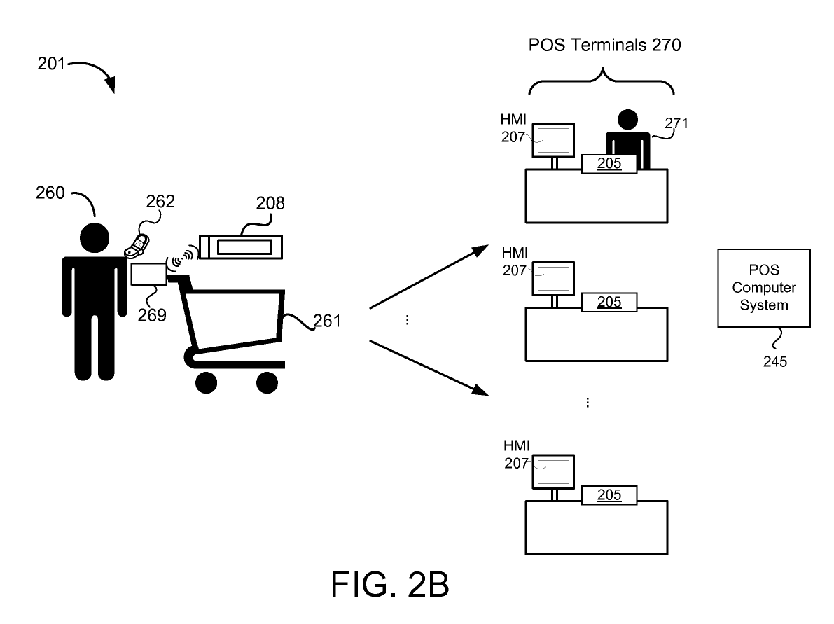

FIG. 2A depicts a schematic diagram 200 of one embodiment of a mobile data gathering apparatus 208 usable in a queue-busting scheme as described above. The apparatus 208 is powered by a chargeable power source 211, such as a battery, fuel cell, capacitor, or the like. The chargeable power source 211 may be charged using an external power source, such as an AC outlet 213. The chargeable power source 211 powers the mobile information gathering apparatus 208 via a power regulation and distribution module 212.

The mobile information gathering apparatus 208 includes a first data capture device 215 to obtain data pertaining to a transaction as described above. The apparatus 208 includes a wireless data capture device 217 configured to obtain customer information from a wireless-enabled customer device 262 (e.g., using NFC, or the like). The data obtained using the wireless data capture device 217 may be converted into a format and/or encoding (POS format) compatible with a corresponding POS computer system (not shown).

The first data capture device 215 and/or the wireless data capture device 217 are managed by a controller 225. As described above, the controller 225 may comprise a processor, such as a processor, FPGA, or the like. The controller 225 is communicatively coupled to a memory 227, which may comprise a non-transitory storage medium having machine-executable instructions stored thereon for performing methods for gathering customer information. The memory 227 may also be used to store data obtained by the data capture devices 215 and/or 217.

Data gathered and/or decoded by the apparatus 208 during a pre-checkout operation (e.g., gathered while the customer 260 is in a checkout queue) is stored on a wireless-enabled storage device 269 (e.g., a wireless-enabled card, token, fob, or the like). In some embodiments, data is transferred to the wireless-enabled storage device 269 as it is gathered by the apparatus 208. Alternatively, the data may be stored on a memory 227 of the apparatus 208, and may be transferred to the wireless-enabled storage device 269 in batches and/or when the gathering is complete. Data may be transferred to the wireless-enabled storage device 269 using the wireless data capture device 217 (or another wireless-enabled device and/or component of the apparatus 208, not shown). Transferring the data may comprise positioning the wireless-enabled storage device 269 in communication range of the information gathering apparatus 208 and/or the wireless data capture device 217.

The wireless-enabled storage device 269 is taken with the customer 260 to a POS checkout terminal where the transaction may be completed. Since the transaction-related information is not tied to any particular POS terminal or queue, the customer 260 may complete the transaction at any available POS terminal (as opposed to a particular POS terminal as in some conventional queue-busting schemes).

FIG. 2B depicts a system 201 for queue busting. In the FIG. 2B example, a mobile information gathering apparatus 208 is used to gather pre-checkout information pertaining to a customer transaction. The information may include a listing of customer items 261 obtained using a first data capture device of the mobile information gathering apparatus 208, such as an optical reader, RFID scanner, or the like. The information may also include information tendered by the customer 260 via a wireless-enabled customer device 262. Tendering customer information may comprise the customer 260 positioning the wireless-enabled customer device 262 in communication range of the apparatus 208 and/or the customer 260 approving wireless information obtained from the wireless-enabled customer device 262 as described above.

The information obtained by the apparatus 208 may be transferred to the wireless-enabled storage device 269. In some embodiments, the apparatus 208 may convert the information into a POS format prior to transfer to the wireless-enabled storage device 269. The customer 260 is given the wireless-enabled storage device 269 and is instructed to complete the transaction at any one of a plurality of POS terminals 270. As discussed above, since the information gathered by the mobile information gathering apparatus 208 is not tied to any particular information gathering apparatus and/or POS terminal 270, the customer 260 may choose to complete the transaction at any of the POS terminals 270. Each POS terminal 270 may comprise a fixed information gathering apparatus 205, which may be configured to access information pertaining to the customer transaction from the wireless-enabled storage device 269.

When the customer 260 reaches one of the terminals 270, the customer 260 (or a terminal operator 271) positions the wireless-enabled storage device 269 in the communication range of the apparatus 205. In some embodiments, one or more of the terminals 270 may be “self-service” terminals that do not have a dedicated operator 271. In these embodiments, the customer 270 is instructed to place the wireless-enabled storage device 269 in the communication range of the apparatus 205 via an HMI 207 of the terminal (e.g., a display, speaker, text prompt, or the like). When the wireless-enabled device 269 is in communication range, the apparatus 205 obtains the information pertaining to the transaction via a contactless, wireless data transfer. The apparatus 205 may also convert the data into a POS format and provide the data to the POS terminal 270 (or backend POS computer system 245). Alternatively, the data may have been converted into the POS format by the mobile information gathering apparatus 208, as described above. The customer 260 completes the transaction and returns the wireless-enabled storage device 269 (and/or deposits the device 269 at the terminal 270). The wireless-enabled storage device 269 may be equipped with anti-theft means, such as a proximity sensor, RFID tag, “wireless handcuffs” as described in U.S. Pat. No. 6,572,019, or other devices to prevent the customer 260 from removing the device 269 from the premises.

In some embodiments, the wireless-enabled storage device 269 may be the property of the customer 260 and, as such, the customer 260 may retain the device 269 upon completion of the transaction. For example, the wireless-enabled storage device 269 may be embedded within a “club card” or other token issued to the customer 260. Alternatively, the device 269 may be embedded within a wireless-enabled device of the customer (e.g., a wireless-enabled customer device 262, such as a smart phone, PDA, or the like). If the customer 260 is to retain the device 269, the transaction may comprise clearing the device 269 of the information pertaining to the transaction and/or transmitting a receipt (or other data) to the wireless-enabled device storage device 269.

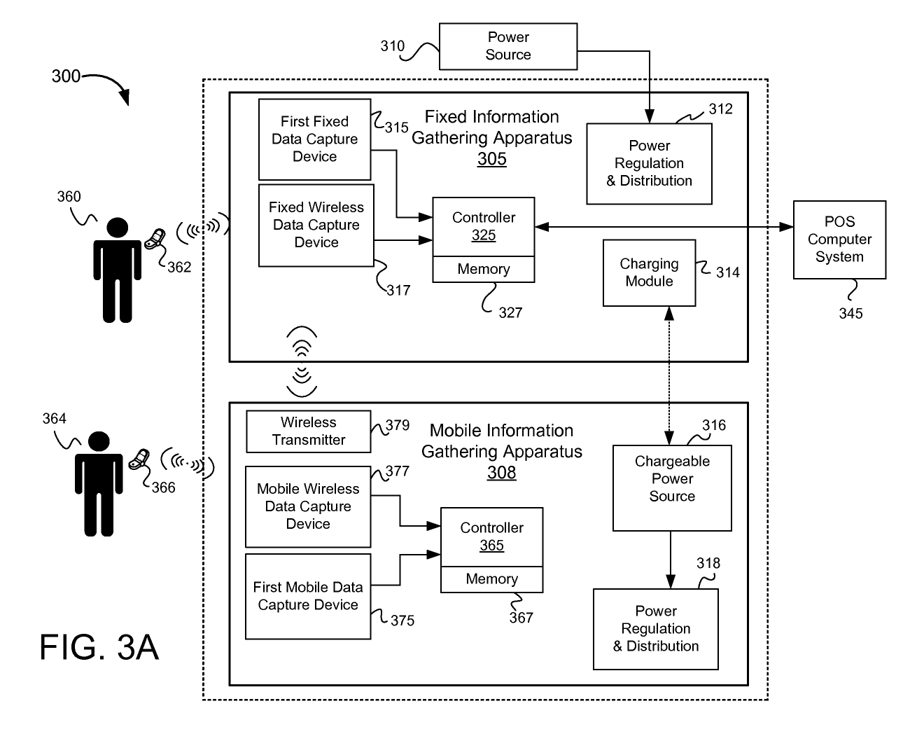

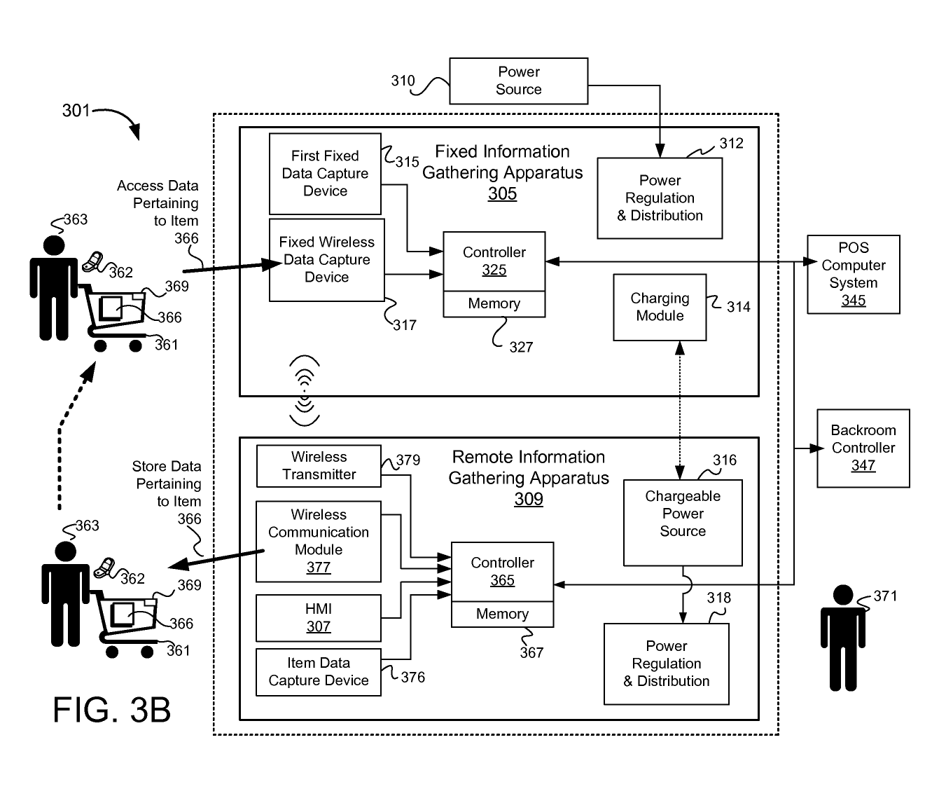

FIG. 3A is a schematic diagram depicting an information gathering system 300 comprising a fixed information gathering apparatus 305 and a mobile information gathering apparatus 308 for use in a queue-busting scheme. The fixed information gathering apparatus 305 is coupled to a power source 310, which feeds a power regulation, and distribution module 312 that operates as described above. The apparatus 305 includes a first fixed data capture device 315 configured to obtain information pertaining to items in a customer transaction. The first fixed data capture device 315 may comprise an optical reader (e.g., barcode scanner), RFID reader, or the like. The apparatus 305 includes a fixed wireless data capture device 317 configured to gather customer information from wireless-enabled devices (e.g., the wireless-enabled customer device 362). The fixed wireless data capture device 317 may comprise an NFC device having a limited communication range. The operation of the data capture devices 315 and 317 may be managed by a controller 325 having a memory 327. The controller 325 is communicatively coupled to a POS computer system 345 and provides data obtained by the first fixed data capture device 315 and/or the fixed wireless data capture device 317 to the POS computer system 345. The controller 325 may be configured to convert data obtained by the fixed wireless data capture device 317 into a POS format that is compatible with the POS computer system 345.

The system 300 includes a mobile information gathering apparatus 308. The mobile information gathering apparatus 308 is powered by a chargeable power source 316 via the power regulation and distribution module 318, which may be charged by a charging module 314 of the fixed information gathering apparatus 305. The chargeable power source 316 may comprise a battery, capacitors, or other mobile power source.

A first mobile data capture device 375 is configured to obtain data pertaining to a customer transaction (e.g., obtain data pertaining to the customer's items for purchase). Accordingly, the first mobile data capture device 375 may comprise a data reader, such as an optical reader (e.g., barcode scanner), RFID reader, or the like. The first mobile data capture device 375 may be configured to obtain data in a format for which the POS computer system 345 is programmed (e.g., a barcode format). The operation of the first mobile data capture device 375 is managed by the controller 365 as described above. The controller 365 is communicatively coupled to a memory 367, which may comprise a non-transitory storage medium having machine-executable instructions stored thereon for performing methods for gathering and decoding information. The memory 367 may also be used to store data obtained by the first mobile data capture device 375 and/or the mobile wireless data capture device 377.

The mobile wireless data capture device 377 may be an NFC device configured to obtain data from a wireless-enabled customer device (e.g., device 366). The mobile wireless data capture device 377 may obtain data from a wireless-enabled customer device 366 responsive to detecting the device 366 in communication range and/or in response to an action by the customer 364 (e.g., the customer 364 indicating approval to tender customer-information using the wireless-enabled device 366). Data obtained by the mobile wireless data capture device 377 may be converted into a POS format that is compatible with the POS computer system 345. The converted data may be stored in the memory 367 during a pre-checkout data gathering process.

The mobile information gathering apparatus 308 may be used in a queue-busting scheme. Examples of queue busting schemes are described in U.S. Published Patent Application No. 2010/0257063 (incorporated by reference above). An operator may use the mobile data capture apparatus 308 to obtain data pertaining to a customer transaction in a pre-checkout process (e.g., while the customer 364 is in a checkout queue). The pre-checkout information gathering apparatus 308 may operate as described above, using the data capture devices 375 and 377. The information gathered by the apparatus 308 is stored on the memory 367 (or other storage medium). When the customer 364 reaches the head of the queue (or otherwise arrives at a fixed POS terminal where the fixed information gathering apparatus 305 is located), the information pertaining to the transaction is communicated from the memory 367 of the mobile information gathering apparatus 308 to the fixed information gathering apparatus 305. The information may be transmitted wirelessly using the mobile wireless data capture device 377 and may be obtained by the fixed wireless data capture device 317. Alternatively, the transfer may be implemented using a separate wireless transmitter 379 and/or using a different communication mechanism, such as IEEE 802.11 wireless, a wired communication link, BLUETOOTH®, or the like. The apparatuses 305 and 308 may associate data of different customers 360 with different identifiers, enabling both information gathering apparatus 305 and 308 to operate concurrently and without substantial modifications to the POS computer system 345.

Alternatively, the mobile information gathering apparatus may obtain customer information independently of any fixed information gathering apparatus 305 or POS terminal. For example, the mobile information gathering apparatus 308 may transfer information obtained in the pre-checkout process to any one of a plurality of fixed information gathering apparatuses and/or may store the information on an intermediate storage device, such as the wireless-enabled storage device 269 described above.

Wireless data capture devices may provide a convenient mechanism for transferring data to/from a POS terminal. Accordingly, in some embodiments, a wireless data capture device, such as the wireless data capture devices 117, 217, 317, and 377 discussed above, may be used to update an information gathering apparatus, POS terminal, or the like. The wireless data capture devices 117, 217, 317, and/or 377 may also be used for non-transaction related data retrieval operations. For example, an operator may upload a software update to an information gathering apparatus wirelessly using, inter alia, the wireless data capture device of the apparatus. The data may be recognized as a software update by the apparatus controller (e.g., controller 125, 225, 325, and/or 365) and stored in a persistent storage location (e.g., in the memory 127, 227, 327, and/or 367). Updating the software may comprise a data authentication step in which the transmitter of the data is authenticated, the integrity and/or source of the data is verified, or the like. The authentication may comprise various authentication mechanisms including, but not limited to: verification of a password or other credential, digital signatures, public key cryptography, a secure communications layer (e.g., Secure Sockets Layer (SSL), etc.), or the like.

The wireless data capture devices disclosed herein (e.g., the wireless data capture devices 117, 217, 317, and/or 367) may also be used for contactless information retrieval. For instance, a wireless data capture device may be configured to provide access to information pertaining to a POS terminal, an information gathering apparatus, or the like. The information retrieved through the wireless data capture device may include, but is not limited to: diagnostic information, test data, and the like.

In some embodiments, a POS system may include a data capture apparatus configured to implement pre-purchase operations. The pre-purchase operations may be performed in addition to the queue busing operations described above. FIG. 3B is a schematic block diagram that depicts one embodiment of a system 301 for performing pre-purchase operations. The system 301 includes a fixed information gathering apparatus 305 and a remote information gathering apparatus 309. Similar to the mobile information gathering apparatus 308 described above, the remote information gathering apparatus 309 may be mobile, and as such, may comprise a chargeable power source 316 and a power regulation and distribution module 318. The disclosure is not limited in this regard, however. In some embodiments, the remote information apparatus 309 may be a fixed information gathering apparatus that is directly coupled to a power source, such as the power source 310.

A customer 363 may perform a pre-purchase operation at the remote information gathering apparatus 309 for an item 366. The item data capture device 376 is configured to obtain data pertaining to the item 366, and may include, but is not limited to, a scanner, a scale, a counter, a data entry terminal, or the like. For example, a remote information gathering apparatus 309 for use at a deli counter and/or produce section may comprise an item data capture device 376, such as a scale to determine the weight of the item 366. The remote information gathering apparatus 309 may comprise a data entry terminal through which an operator 371 may enter information pertaining to the quantity and/or type of the item 366 (e.g., the number and/or type of items in a parts bag 366), and so on. The item data capture device 376 may be further configured to obtain information to identify the item 366, such as a bar code, UPC code, item code, or the like.

The controller 365 may access pricing information for the item 366, which may include, but is not limited to, the price per weight of the item 366, price per quantity of the item 366, or the like. The controller 365 may access the pricing information from a backroom controller 347, which may be accessible via a wireless transmitter 379 (as described above) and/or via a direct connection (e.g., a network interface of the controller 365). Alternatively, the pricing information may be entered by the operator 371, accessed from the memory 367, or other storage device.

The controller 365 determines a price of the item 366 using the type, quantity, and/or pricing information of the item 366. The item price may be presented on one or more human-machine interface components 307 (e.g., a display) for approval by the customer 363 and/or operator 371. In some embodiments, the item price may be printed onto a tag or label, which may be affixed to the item 366 for processing in a point of sale transaction.

In some embodiments, the remote information gathering apparatus 309 includes a wireless communication module 377 that may be configured to store information pertaining to the item 366 on the customer wireless-enabled device 362 and/or a wireless-enabled storage device 369. In the system 301 depicted in FIG. 3B, the wireless-enabled storage device 369 is built into the cart 361, and the customer 363 may not be aware that the wireless storage device 369 is in use. Alternatively, the wireless-enabled storage device 369 may comprise a card, fob, or the like, as described above. The wireless communication module 377 may store information pertaining to the item 366 on the wireless-enabled customer device 362 and/or wireless-enabled storage device 369 (e.g., the price of the item 366, an item identifier, quantity, weight, and so on). The remote information gathering apparatus 309 may secure the information using a cryptographic signature, credential, encryption, or the like.

In some embodiments, the remote information gathering apparatus 309 may be configured to store the information pertaining to the item 366 on the backroom controller 347 (or other storage service), rather than on the wireless-enabled storage device 369 and/or wireless-enabled customer device 362. A link to the stored information may be pushed to the wireless-enabled storage device 369 and/or wireless-enabled customer device 362. The link may be secured using a cryptographic signature, credential, encryption, or the like, as described above.

The customer 363 proceeds to the fixed information gathering apparatus 305 to complete the transaction. The transaction may comprise purchasing the item 366 (along with other items, not shown). The fixed wireless capture device 317 gathers customer information from, inter alia, wireless-enabled devices (e.g., the wireless-enabled customer device 362). The fixed wireless capture device 317 may gather the information pertaining to the item 366 that was stored by the remote information gathering apparatus 309. Alternatively, or in addition the fixed wireless capture device 317 may access the information on a storage service (e.g., the backroom controller 347) using a link stored by the remote information gathering apparatus 309. The fixed information gathering apparatus 305 may use the information to complete the transaction, as described above. Alternatively, or in addition, the fixed information gathering apparatus 305 may verify printed label information using the information (e.g., may verify that the label has not been tampered with, comprises the same information as stored on the wireless-enabled device 362, 369, or the like). In some embodiments, the fixed information gathering apparatus 305 authenticates the information (and/or link) obtained from the wireless-enabled device 362, 369, which may comprise verifying a signature, verifying a credential, decrypting the information (or link), or the like.

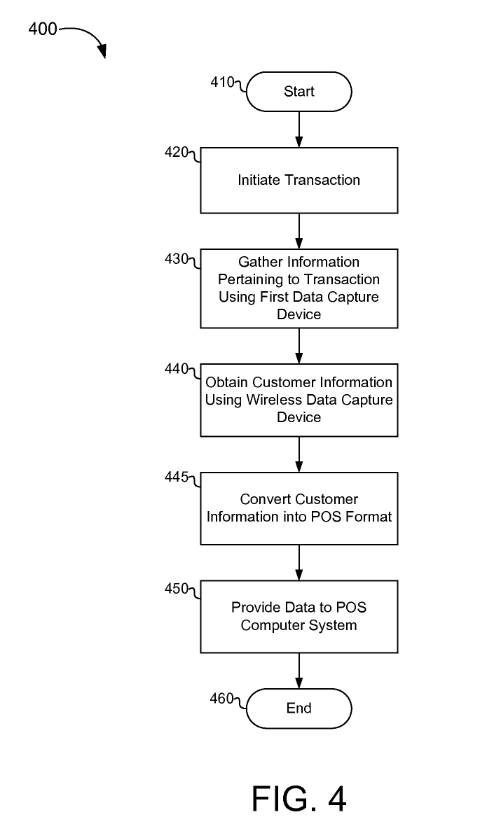

FIG. 4 is a flow chart of one embodiment of a method 400 for gathering information. Steps of the method 400 may be implemented as executable instructions stored on a non-transitory machine-readable storage medium, such as the memory 127, 227, 327, and/or 367 described above. The instructions may be configured to cause a machine (e.g., the controller 125, 225, 325, and/or 365 or the like) to implement one or more of the steps of the method 400. Certain steps of the method 400 may be tied to particular machine components, such as data capture devices, human-machine interface components (e.g., displays, input devices, etc.), communication interfaces, and the like. In some embodiments, steps of the method 400 (as well as methods 500, 600, and 700 below) may be reordered and/or omitted.

At step 410, the method 400 may start and be initialized, which may comprise a machine reading one or more machine-executable instructions from a non-transitory machine-readable storage medium. As described above, the instructions may be configured to cause the machine to perform one or more steps of the method 400. Step 410 may further comprise allocating and/or initializing resources of the method 400, such as communication interfaces, data capture devices, and so on.

At step 420, a customer transaction may be initiated. Step 420 may comprise a customer arriving at a fixed POS terminal and/or an operator initiating a pre-checkout information gathering operation using a mobile information gathering apparatus.

At step 430, data pertaining to a transaction (e.g., customer purchases) may be gathered by a first data capture device. Step 430 may comprise reading barcodes from printed media on the customer items, reading RFID tags, weighing items, entering item codes, and so on. In some embodiments, step 430 comprises storing information pertaining to the transaction on a wireless-enabled customer device and/or wireless-enabled storage device, as described above in conjunction with FIG. 3B.

At step 440, customer data is obtained from a wireless-enabled customer device using a wireless data capture device, such as an NFC device or the like. The information obtained at step 440 may include, but is not limited to: qualification information (e.g., age verification), membership information, loyalty information, coupons, payment information, and so on. Step 440 may comprise the customer (or other operator) placing a wireless-enabled customer device into communication range of the wireless data capture device. In some embodiments, step 440 includes prompting the customer to position a wireless-enabled customer device into communication range of the wireless data capture device. Step 440 may further comprise receiving approval from the customer for wireless data capture.

In some embodiments, steps 430 and 440 may be performed concurrently, such that information pertaining to the transaction is obtained using the first data capture device while the wireless data capture device obtains customer information from the wireless-enabled customer device.

At step 445, data obtained using the wireless data capture device may be converted (e.g., reformatted and/or re-encoded) into a format that is compatible with a POS computer system (e.g., POS format, such as a barcode format).

At step 450, the data obtained by the first data capture device at step 420 and the data obtained by the wireless data capture device at step 440 (and converted at step 445) are provided to a POS computer system. The POS computer system may use the data to complete the customer transaction.

At step 460, the flow ends until another customer transaction is initiated, at which point the operation may return to step 420.

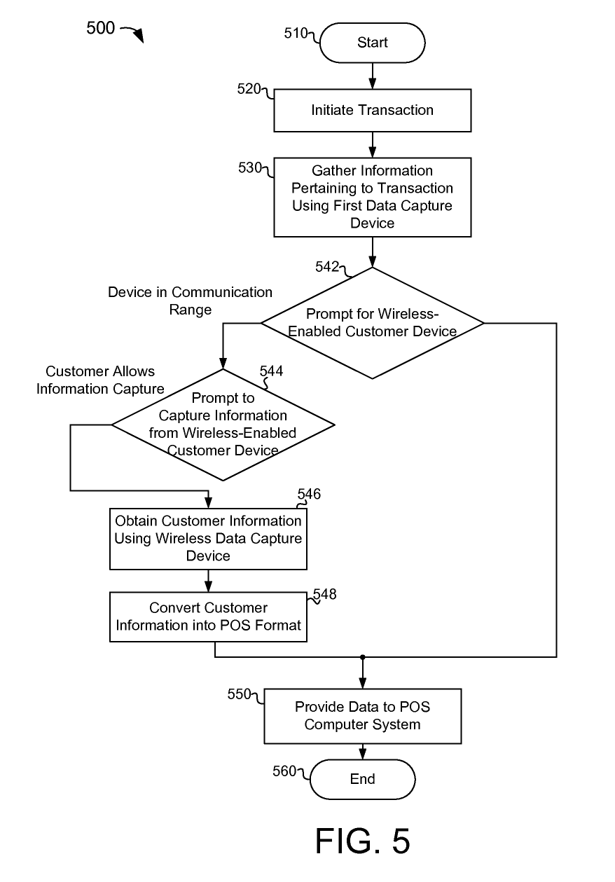

FIG. 5 is a flow chart of another embodiment of a method 500 for gathering information.

At steps 510, 520, and 530, the method 500 starts and is initialized, a customer transaction is initiated, and information pertaining to the transaction is gathered using a first data capture device as described above.

At step 542, the customer is prompted to place a wireless-enabled customer device into communication range of a wireless data capture device, such as an NFC device. The prompt may be issued by an operator, a user interface element on a POS terminal, or the like. When a wireless-enabled customer device is detected in communication range, the flow continues at step 544; otherwise, the flow continues to step 550.

At step 544, the customer may be prompted to approve capturing information from the wireless-enabled device. The approval may be an “omnibus” approval that applies to all applicable transaction-related customer information stored on the wireless-enabled customer device. Alternatively, or in addition, the prompt may comprise the customer selectively indicating which information (if any) is to be obtained from the wireless-enabled device. The selecting may comprise the customer selecting a payment options for the transaction; for instance, the wireless-enabled device may have information pertaining to a number of different payment mechanisms, and the customer may select which of these mechanisms are to be used in the transaction.

The approval process of step 544 may be predicated on privacy settings. As discussed above, some information on a wireless-enabled device may be considered to be private or sensitive. Designation of such information may be made by the customer, by convention, the inference by the method 500, by pre-established privacy settings of the customer (stored by the POS computer system), or the like. Information that is potentially private and/or sensitive may include, but is not limited to: payment information, qualification information (e.g., age verification), customer indentifying information (e.g., driver's license number, etc.), and the like. Step 544 may comprise prompting the customer for approval before capturing this information. The prompt may be issued by an operator of a POS terminal, displayed on a HMI of the information gathering apparatus, displayed on the wireless-enabled customer device, or other suitable location and/or device. Upon customer approval, the flow continues at step 546; otherwise, the flow continues to step 550.

At step 546, the wireless data capture device obtains information from the wireless-enabled customer device. The information obtained at step 546 may be limited to the information the customer approved for wireless capture at step 544.

At step 548, the information obtained wirelessly at step 546 may be converted into a POS format that is compatible with a corresponding POS system, such as a barcode format.

At step 550, the information gathered at step 530 and/or at step 542-548 is provided to the POS computer system, which may complete the customer transaction. If the customer chooses not to authorize wireless information capture at steps 542 and/or 544, the customer may be prompted provide this information manually at step 550 (e.g., manually present coupons, loyalty card information, age verification, identity, and so on). The method 500 ends at step 560 until a next customer transaction is initiated, at which point the flow may continue at step 520.

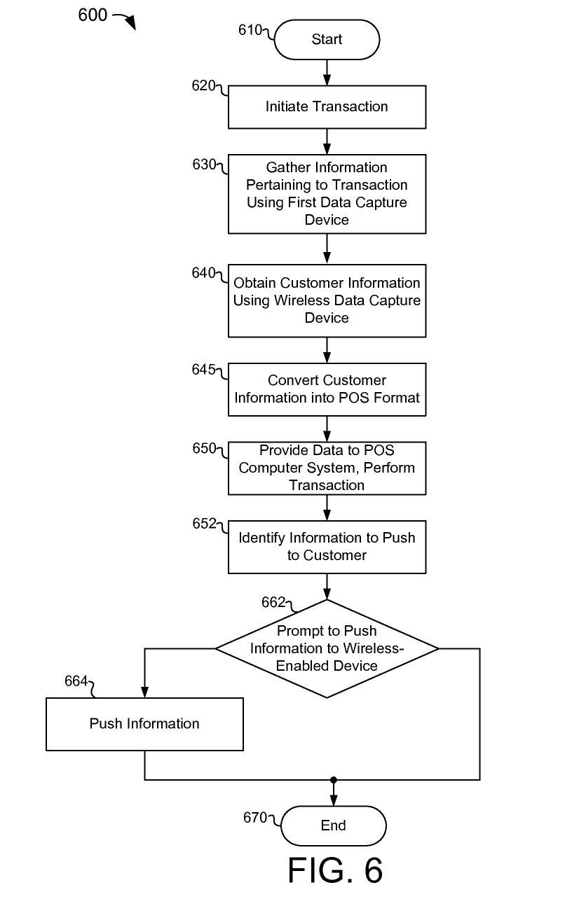

FIG. 6 is a flow chart of another embodiment of a method 600 for gathering information. At steps 610-650, the method 600 starts and is initialized, obtains information using a first data capture device and a wireless data capture device, converts the information into a POS format, and provides the information to a POS computer system.

At step 652, while performing the POS transaction for the customer, the POS computer system identifies information that is available to be “pushed” onto a wireless-enabled customer device. The information may include, but is not limited to: promotional materials (e.g., information regarding upcoming sales, promotions, or the like); customer loyalty rewards information (e.g., current rewards point balance); an electronic receipt; warranty information, rebate redemption information, store account information (e.g., the current balance on a customer credit account); coupons; or the like.

The customer is prompted to allow the identified information to be transmitted to the wireless-enabled customer device at step 662. The prompt may be made by a POS operator, may be displayed on a POS terminal, may be displayed on an interface component of the wireless-enabled customer device, or the like. When the customer indicates acceptance of the information (and/or particular portions thereof), the flow continues to step 664; otherwise, the flow continues to step 670.

At step 664, the wireless data capture device (or other wireless-enabled device of the POS system) transmits the identified information (or portions thereof) to the wireless-enabled customer device. Step 670 may include the customer (or other entity) positioning the wireless-enabled customer device into communication range of the information transfer device. Although FIG. 6 shows the pushing of information occurring after completing a POS transaction, information could be pushed to the wireless-enabled customer device at any time during the transaction. Accordingly, the present disclosure should not be read as limited in this regard.

At step 670, the method 600 ends until a next customer transaction is initiated, at which point the operations may continue at step 620.

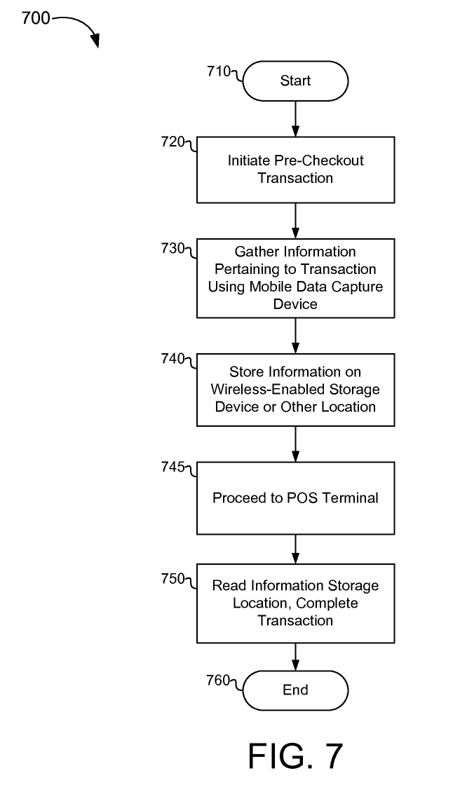

FIG. 7 is a flow chart of one embodiment of a method 700 for queue busting. At step 710, the method 700 starts and is initialized as described above.

At step 720, a pre-checkout data capture operation is initiated. Step 720 may comprise a POS operator approaching a customer that is standing in a checkout queue. The pre-checkout data capture operation may be initiated before associating the customer with any particular POS terminal; the customer may be in a common queue that feeds into one of a plurality of POS terminals (as shown in FIG. 2B). Alternatively, the pre-checkout operation may be associated with a particular POS terminal and/or fixed information gathering apparatus.

At step 730, information pertaining to the customer transaction may be gathered by a mobile information gathering apparatus, such as the apparatus 208 of FIGS. 2A and 2B, apparatus 308 of FIG. 3A, and/or remote apparatus 309 of FIG. 3B. Step 730 may comprise obtaining information using a first data capture device (e.g., a mobile scanner, RFID reader, or the like) and/or a wireless data capture device, such as an NFC device. Step 730 may comprise converting the data obtained using the wireless data capture device into a POS format. The information obtained at step 730 may include, but is not limited to: the items to be purchased in the transaction, customer qualification information (e.g., age, identifier, etc), coupons, payment information, and so on). Capturing the information at step 730 may comprise prompting the customer to place a wireless-enabled customer device into wireless communication range of the mobile information gathering apparatus, the customer approving wireless information transfer, and so on, as described above.

At step 740, the information pertaining to the transaction gathered at step 730 is stored. The storage operation of step 740 may comprise storing the information on a wireless-enabled storage device, such as a wireless-enabled card, fob, token, or the like. The transfer may be performed using the wireless data capture device of the mobile information gathering apparatus. Alternatively, or in addition, the information may be stored in a memory of the mobile information gathering apparatus (or other memory storage).

At step 745, the customer proceeds to a POS terminal. Step 745 may comprise providing the wireless-enabled storage device to the customer and/or associating the customer with an identifier or token. The customer may present the wireless-enabled storage device at the POS terminal to complete the transaction.

At step 750, the POS terminal reads the information pertaining to the customer transaction. The information may be read from the wireless-enabled storage device, from a memory of the mobile information gathering apparatus, or another storage location. The information is provided to a POS computer system, which may complete the transaction. Step 750 may comprise gathering additional information that was not gathered at step 730, such as information that is not practical to gather using a mobile information gathering apparatus (e.g., item weight) and/or customer information that could not be gathered using the mobile wireless data capture device.

At step 760, the operations end until a next pre-checkout process is initiated, at which point the flow may continue at step 720.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a non-transitory machine-readable storage medium having stored instructions thereon that may be used to program a computer (or other electronic device) to perform processes described herein. The non-transitory machine-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or non-transitory machine-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communication network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention.

1. A method for gathering information in a point-of-sale (POS) system, the method comprising:
gathering information pertaining to a customer transaction using a first data capture device;
obtaining customer information from a wireless-enabled customer device using a wireless data capture device;
converting the information obtained from the wireless-enabled customer device into a format that is compatible with the POS system; and
providing the information gathered using the first data capture device and the converted information obtained from the wireless data capture device to the POS system.

2. The method of claim 1, wherein the wireless data capture device is a Near Field Communication device.

3. The method of claim 1, wherein the wireless-enabled customer device is a smart phone.

4. The method of claim 1, wherein the converted customer information obtained from the wireless data capture device comprises one of customer payment information, customer loyalty information, and a coupon.

5. The method of claim 1, further comprising requesting approval to obtain the customer information from the wireless-enabled customer device, and obtaining the customer information in response to receiving approval.

6. The method of claim 1, further comprising pushing information to the wireless-enabled customer device.

7. The method of claim 6, wherein the information comprises a coupon.

8. The method of claim 1, further comprising completing a transaction at the POS system using the converted customer information obtained using the wireless data capture device.

9. The method of claim 1, further comprising:
gathering the information pertaining to the customer transaction at a remote information gathering apparatus; and
storing the information obtained at the remote information gathering apparatus on one of the wireless-enabled storage device and the wireless-enabled customer device.

10. The method of claim 9, further comprising gathering the information pertaining to the customer transaction from one of a wireless-enabled storage device and the wireless-enabled customer device.

11. The method of claim 9, wherein the remote information gathering apparatus is a mobile information gathering apparatus.

12. The method of claim 9, further comprising:
gathering the information pertaining to the customer transaction at a remote information gathering apparatus; and
storing a link to information obtained at the remote information gathering apparatus on one of the wireless-enabled storage device and the wireless-enabled customer device.

13. A system for gathering transaction information, comprising:
a first data capture device to gather information pertaining to a customer transaction; and
an information gathering apparatus comprising a wireless data capture device, wherein the information gathering apparatus is configured to use the wireless data capture device to obtain customer information from a wireless-enabled customer device, to convert the customer information into a format that is compatible with a point-of-sale (POS) system, and to provide the converted customer information and the information obtained using the first data capture device to the POS system.

14. The system of claim 13, further comprising:
a remote information gathering apparatus comprising the first data capture device; and
a wireless-enabled data storage device to store the information pertaining to the customer transaction obtained by the first data capture device, wherein the information gathering apparatus obtains the information pertaining to the customer transaction from the wireless-enabled data store device.

15. The system of claim 14, wherein the remote information gathering apparatus is a mobile information gathering apparatus.

16. The system of claim 13, further comprising:
a remote information gathering apparatus comprising the first data capture device; and
a wireless-enabled data storage device to store a link to the information pertaining to the customer transaction obtained by the first data capture device, wherein the information gathering apparatus obtains the information pertaining to the customer transaction obtained by the first data capture device using the link.

17. The system of claim 13, wherein the information gathering apparatus comprises the first data capture device.

18. The system of claim 13, wherein the wireless-enabled customer device comprises a Near Field Communication device.

19. The system of claim 13, wherein the wireless-enabled customer device comprises a smartphone.

20. The system of claim 13, wherein the information gathering apparatus is configured to request permission to obtain the customer information from the wireless-enabled customer device and obtains the customer information in response to a customer accepting the request.

21. The system of claim 13, wherein the information gathering apparatus is configured to push information to the wireless-enabled customer device.

22. The system of claim 13, wherein the information gathering apparatus is configured to wirelessly receive update data and to update one of configuration data and firmware of the fixed information gathering device using the update data.

23. The system of claim 13, wherein the information gathering apparatus is configured to transmit diagnostic data pertaining to the information gathering apparatus to a wireless-enabled storage device.

24. A non-transitory machine-readable storage medium comprising instructions to cause a computing device to perform a method, comprising:
gathering information pertaining to a customer transaction using a first data capture device;
obtaining customer information from a wireless-enabled customer device using a wireless data capture device;
converting the information obtained from the wireless-enabled customer device into a format that is compatible with a point-of-sale (POS) system; and
providing the information gathered using the first data capture device and the converted information obtained from the wireless data capture device to the POS system.

25. The non-transitory machine-readable storage medium of claim 24, the method further comprising gathering the information pertaining to the customer transaction from one of a wireless-enabled storage device and the wireless-enabled customer device.

26. The non-transitory machine-readable storage medium of claim 25, the method further comprising:
gathering information pertaining to the customer transaction at a remote information gathering apparatus; and
storing the information obtained at the remote information gathering apparatus on one of the wireless-enabled storage device and the wireless-enabled customer device.

27. The non-transitory machine-readable storage medium of claim 25, further comprising:
gathering information pertaining to the customer transaction at a remote information gathering apparatus; and
storing a link to information obtained at the remote information gathering apparatus on one of the wireless-enabled storage device and the wireless-enabled customer device.
